(19) United States
(12) Patent Application Publication
(10) Pub. No.: US 2023/0316823 A1
(43) Pub. Date: Oct. 5, 2023

(54) IN-VEHICLE DEVICE, CONTROL METHOD, AND STORAGE MEDIUM

(71) Applicant: TOYOTA JIDOSHA KABUSHIKI KAISHA, Toyota-shi (JP)

(72) Inventor: Yuji KAWAI, Toyota-shi (JP)

(21) Appl. No.: 18/158,488

(22) Filed: Jan. 24, 2023

(30) Foreign Application Priority Data
Apr. 5, 2022 (JP) 2022-062892

(51) Int. Cl. G07C 5/04

(52) U.S. Cl. CPC G07C 5/04

(57) ABSTRACT

The in-vehicle device includes an identification unit that specifies an index based on a change amount of a state of a user's body detected in a vehicle controlled by an automatic driving function or a driving assistance function, and a storage unit that stores data related to the vehicle in association with the index so as to correspond to the timing of the change in the state.

### CROSS-REFERENCE TO RELATED APPLICATION

This application claims priority to Japanese Patent Application No. 2022-062892 filed on Apr. 5, 2022, incorporated herein by reference in its entirety.

### BACKGROUND

### 1. Technical Field

The present disclosure relates to an in-vehicle device, a control method, and a storage medium.

### 2. DESCRIPTION OF RELATED ART

A technique for recording data regarding travel of a vehicle is known. Japanese Unexamined Patent Application Publication No. 2019-164403 (JP 2019-164403 A) discloses a technique for recording video data of which an image is captured when a predetermined event such as a large change in acceleration occurs in a vehicle.

### SUMMARY

It is desired to record data more effectively in a vehicle controlled by an automatic driving function or a driving assistance function.

An object of the present disclosure is to provide a technique for recording data more effectively in the vehicle controlled by the automatic driving function or the driving assistance function.

An in-vehicle device according to one aspect of the present disclosure includes:

an identification unit that identifies an index based on a change amount of a state of a body of a user detected in a vehicle controlled by an automatic driving function or a driving assistance function; and
a storage unit that stores data related to the vehicle in association with the index such that a timing of acquisition of the data corresponds to a timing of a change of the state.

A control method according to one aspect of the present disclosure includes a control method performed by a processor of an in-vehicle device, and the control method includes:

identifying an index based on a change amount of a state of a body of a user detected in a vehicle controlled by an automatic driving function or a driving assistance function; and storing a storage unit that stores data related to the vehicle in association with the index such that a timing of acquisition of the data corresponds to a timing of a change of the state.

A storage medium according to one aspect of the present disclosure includes a program that causes a computer to function as an in-vehicle device, and the in-vehicle device includes:

an identification unit that identifies an index based on a change amount of a state of a body of a user detected in a vehicle controlled by an automatic driving function or a driving assistance function; and a storage unit that stores data related to the vehicle in association with the index such that a timing of acquisition of the data corresponds to a timing of a change of the state.

According to the present disclosure, it is possible to provide a technique for recording data more effectively in the vehicle controlled by the automatic driving function or the driving assistance function.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a system according to an embodiment;

FIG. 2 is a block diagram illustrating a schematic configuration of hardware of a part of a vehicle according to an embodiment;

FIG. 3 is a block diagram showing a schematic configuration of a part of the functions of the in-vehicle device in an embodiment; and

FIG. 4 is a flowchart illustrating a process flow of the in-vehicle device according to the embodiment.

### DETAILED DESCRIPTION OF EMBODIMENTS

Hereinafter, an embodiment of the present disclosure will be described. Note that the following embodiments are examples for describing the present disclosure, and are not intended to limit the present disclosure to only the embodiments. Moreover, various modifications can be made to the present disclosure without departing from the gist thereof. Further, a person skilled in the art can adopt an embodiment in which each element described below is replaced with an equivalent one, and such an embodiment is also included in the scope of the present disclosure.

System Configuration

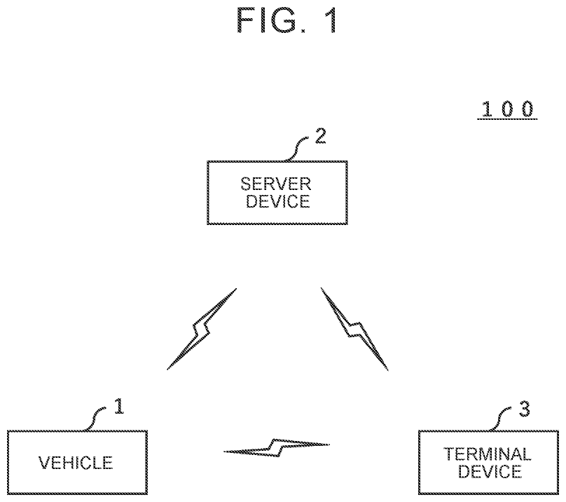

Referring to FIG. 1, an exemplary configuration of a system 100 according to an embodiment will be described. In the present embodiment, the system 100 includes a vehicle 1, a server device 2, and a terminal device 3. Each of the vehicle 1, the server device 2, and the terminal device 3 is configured to be able to communicate with each other wirelessly or wirelessly (or by both of them). In the example shown in FIG. 1, the vehicle 1 provided by the system 100, the server device 2, and the number of the terminal device 3 is one, respectively, but is not limited thereto, the vehicle 1, the server device 2, and the number of the terminal device 3 may be two or more. The system 100 may not include at least one of the server device 2 and the terminal device 3.

The vehicle 1 is a mobile body capable of communicating with the outside. Driving of the vehicle 1 is controlled by at least one of an automatic driving function and a driving assistance function. The automatic driving function is an autonomous driving function of the vehicle. The driving assistance function is a function of assisting the driver in driving based on the behavior of the driver of the vehicle, the state of the vehicle, or the like.

The server device 2 stores and manages data received from the vehicle 1. Further, the server device 2 may transmit a control command to the vehicle 1 to the vehicle 1. The server device 2 includes an information processing device such as a server computer. The server device 2 may be configured by one information processing device or may be configured by a plurality of information processing devices (for example, cloud computing or edge computing).

The terminal device 3 has a function of diagnosing a state of the vehicle 1 based on data received from the vehicle 1 or the server device 2. The terminal device 3 includes, for example, a personal computer, a smartphone, a tablet terminal, or a general-purpose or dedicated information processing device for a specific purpose.

Hardware Configuration

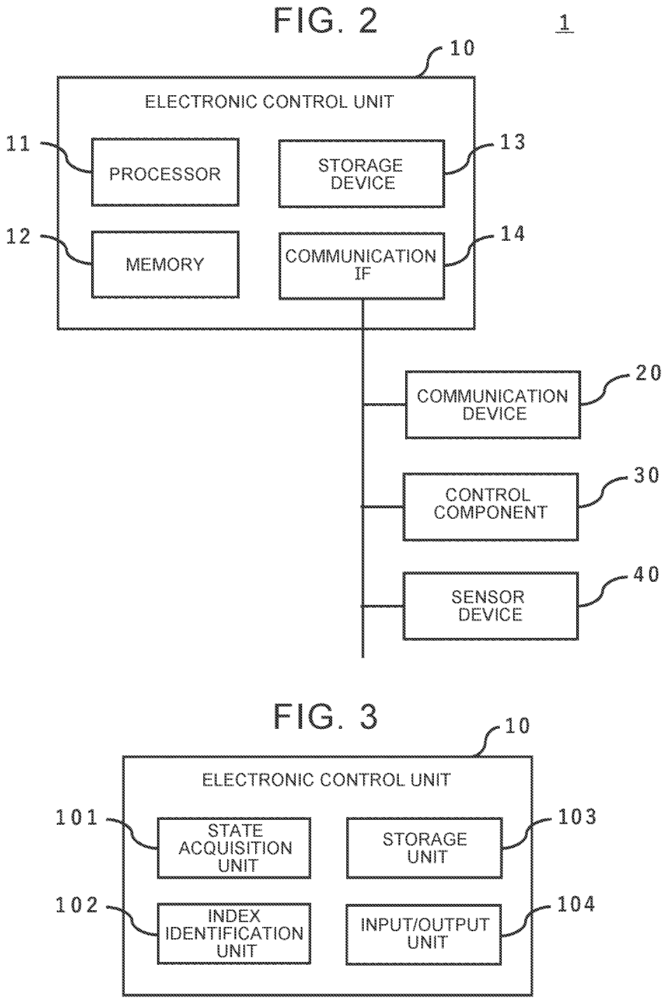

A part of the hardware configuration of the vehicle 1 will be described with reference to FIG. 2. The vehicle 1 includes, as a hardware configuration, an electronic control unit 10, a control component 30, and a sensor device 40.

The electronic control unit 10 is an in-vehicle device configured using a computer for controlling processing and operations of various configurations of the vehicle 1. The electronic control unit 10 includes a processor 11, a memory 12, a storage device 13, and a communication interface 14. The processor 11 is a Central Processing Unit (CPU). The memory 12 is a storage unit that stores data necessary for various kinds of processing by the processor 11 and data of processing results. The storage device 13 is a large-capacity storage unit, and may be configured by Hard Disk Drive (HDD), SSD (Solid State Drive), or the like. The communication interface 14 includes an interface circuit for communicatively connecting the electronic control unit 10 to a configuration external to the electronic control unit 10. The communication interface 14 performs communication via an in-vehicle network conforming to a standard such as Controller Area Network (CAN, for example.

The communication device 20 is an in-vehicle device for performing wireless or wired communication with an external device of the vehicle 1. The control component 30 includes, for example, control components of various configurations mounted on the vehicle 1 such as an internal combustion engine, an electric motor, and an air conditioner. The sensor device 40 is various sensors for acquiring data indicating a state and a situation of the vehicle 1 and the driver. Sensor device 40 includes, for example, cameras, voice sensors, speed sensors, gyro sensors, temperature sensors, inter-vehicle distance sensors, and positioning units.

Function Configuration

A part of the functional configuration of the electronic control unit 10 will be described with reference to FIG. 3. The functional configuration of the electronic control unit 10 is realized by the processor 11 reading and executing a computer program stored in the memory 12 or the storage device 13. The electronic control unit 10 includes, as functional components, a state acquisition unit 101, an index identification unit 102, a storage unit 103, and an input/output unit 104.

The state acquisition unit 101 acquires data related to the state of the body of the user who is the driver detected in the vehicle 1. Data relating to the state of the body of the user is acquired based on the data detected by the sensor device 40. The data relating to the state of the body of the user includes, for example, voice data emitted from the user and image data of the body of the user.

The index identification unit 102 specifies an index based on the change amount of the state on the basis of the data related to the state of the user's body acquired by the state acquiring unit 101. The index may be calculated and specified by the index identification unit 102, or may be specified by the index identification unit 102 acquiring the index from the outside.

The amount of change in the state of the user's body includes, for example, at least a portion of the amount of change in the volume of the voice emitted by the user and the amount of change in the body that is identified based on an image of the user's body. The amount of change in the body specified based on the image of the body of the user includes, for example, at least a part of the amount of change in the color of the face of the user, the expression, the position of the pupil, the size of the pupil, and the amount of change in the arm or other body position. That is, the index may be calculated based on a change amount of at least a part of a voice amount, an expression, a face color, a pupil position, a pupil size, and a body position of the user. The amount of change in the state of the user's body is, for example, the amount of change in a predetermined period (e.g., 3 seconds).

For example, the index may be calculated so as to indicate a higher priority as the amount of change in the state of the body of the user increases. The priority may include, for example, three stages of “high”, “medium”, and “low”. The index may be calculated by a numerical value, and the priority may be set in accordance with a numerical range of the index set in advance. For example, it is assumed that the index is calculated in a range of 0 to 100. In this case, for example, the priority may be set to “low” when the index is 0 or more to less than 30, the priority may be set to “medium” when the index is 30 or more to less than 40, and the priority may be set to “high” when the index is 40 to 100.

The index identification unit 102 may specify the index in response to the occurrence of a predetermined event related to the control by the automatic driving function or the driving assistance function of the vehicle 1. The predetermined event includes an accelerator, a brake, a stop/start of an engine, a warning, and the like caused by the automatic driving function or the driving assistance function.

The storage unit 103 stores various types of data related to the vehicle 1. The data stored in the storage unit 103 as the data related to the vehicle 1 includes, for example, data acquired by the sensor device 40. The data stored in the storage unit 103 as data related to the vehicle 1 may include data indicating at least a part of a load state of the processor 11, a usage rate of the memory 12, a communication state by the communication device 20, and a state of the control component 30. For example, the storage unit 103 continuously stores data related to the vehicle 1, such as a state of the vehicle 1 (including a state inside and outside the vehicle 1) acquired by the sensor device 40, and data indicating a state of a user who is a driver of the vehicle 1.

The storage unit 103 may store the data related to the vehicle 1 in association with the index so as to correspond to the timing of the change in the state of the body of the user. That is, the storage unit 103 may store the index specified by the index identification unit 102 based on the change and the data related to the vehicle 1 in association with each other so that the timing of the occurrence of the change and the timing of the acquisition of the data related to the vehicle 1 correspond to each other when a change in the state of the body of the user occurs. For example, when a predetermined amount of change occurs in the physical condition of the user in the date and time T1, the storage unit 103 stores an index specified based on the change and data related to the vehicle 1 in the date and time T1 in association with each other. Further, the storage unit 103 may store, in association with the index, the data related to the vehicle 1 in a predetermined period (10 seconds before and after the timing of occurrence of the change) including, for example, the timing of occurrence of the change in the state of the body of the user.

As described above, according to the present embodiment, the index identification unit 102 specifies an index based on the amount of change in the state of the body of the user who is the driver detected in the vehicle 1 controlled by the automatic driving function or the driving assistance function. The storage unit 103 stores data related to the vehicle 1 in association with the index so as to correspond to the timing of the change in the state of the body of the user. As a result, in a case where a predetermined amount of change occurs in the state of the body of the user, it is possible to easily identify the data related to the vehicle 1 when the change occurs, out of the data stored in the storage unit 103. That is, according to the present embodiment, it is possible to record data more effectively in a vehicle controlled by an automatic driving function or a driving assistance function.

Further, as described above, the index identification unit 102 specifies the index in response to the occurrence of a predetermined event related to the control by the automatic driving function or the driving assistance function of the vehicle 1. The change in the state of the user's body when the event occurs may be a response of the user to the event. Therefore, by specifying the index in response to the occurrence of the event and storing the data related to the vehicle 1 in the storage unit 103 in association with the index, it is possible to store the data related to the vehicle 1 when there is some reaction to the event in the storage unit 103 with a high priority, and it is also possible to easily identify the data from the storage unit 103.

In addition, as described above, the index is calculated so as to indicate a higher priority as the amount of change in the state of the body of the user increases, for example. Further, the storage unit 103 stores data related to the vehicle 1 stored in association with the index with a higher priority than other data. A change in the state of the user's body may correspond to a positive or negative response indicated by the user to the event. Therefore, by specifying the index in response to the occurrence of the event and storing the data related to the vehicle 1 in the storage unit 103 in association with the index, it is possible to store the data related to the vehicle 1 at the timing when the user shows a positive reaction or a negative reaction to the event in the storage unit 103 with a high priority, and it is also possible to easily specify the data from the storage unit 103.

The storage unit 103 may store the data for a long period of time as the index associated with the data related to the vehicle 1 indicates a higher priority. By storing and managing data in this way, it is possible to store data of a high priority in the storage unit 103 for a long period of time by comparing the data with other data, and as a result, it is possible to effectively store and manage data in a storage area of a limited capacity.

The input/output unit 104 inputs data stored in the storage unit 103 to the electronic control unit 10 and outputs data stored in the storage unit 103 from the electronic control unit 10. The input/output unit 104 outputs, for example, data related to the vehicle 1 stored in the storage unit 103 in response to an output request for data received by the electronic control unit 10 from the server device 2 or the terminal device 3 via the communication device 20. The output request may include a condition for data to be output, such as a timing at which data related to the vehicle 1 is stored, or an index associated with the data. The input/output unit 104 may output data related to the vehicle 1 satisfying the above condition. The data output from the input/output unit 104 may be transmitted to the server device 2 or the terminal device 3 via the communication device 20.

The input/output unit 104 may preferentially output the data as the index associated with the data related to the vehicle 1 stored in the storage unit 103 indicates a higher priority. For example, in response to a data output request from the server device 2 or the terminal device 3, the input/output unit 104 may first output only data associated with the index having a priority of “high”, and then output data associated with the index having a priority of “medium”.

Process Flow

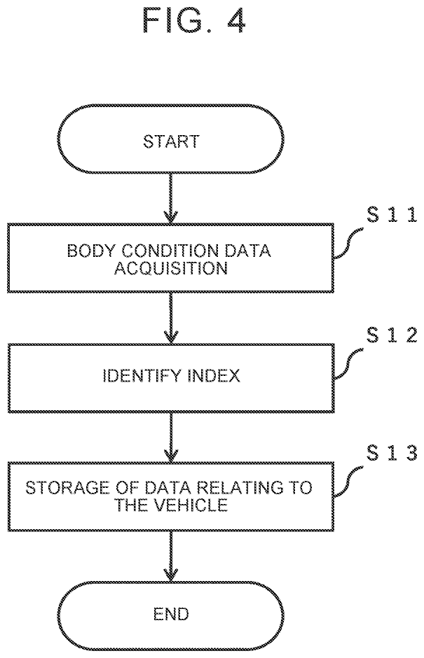

An example of a processing flow in the electronic control unit 10 will be described with reference to FIG. 4. This processing is realized, for example, by the processor 11 reading and executing a computer program stored in the memory 12 or the storage device 13. In the following description, the description of the processing already described will be simplified or omitted.

In a S11 of steps, the electronic control unit 10 obtains information relating to the physical condition of the user who is the driver detected in the vehicle 1. Data relating to the state of the body of the user is acquired based on the data detected by the sensor device 40.

In the step S12, the electronic control unit 10 identifies an index based on the change amount of the state based on the data regarding the state of the body of the user acquired in the step S11. The index may be calculated based on, for example, a change amount of at least a part of a voice amount, an expression, a facial color, a position of a pupil, a size of a pupil, and a body position of the user specified in accordance with the data related to the state of the body of the user acquired in the step S11.

In the step S13, the electronic control unit 10 stores data relating to the vehicle 1 in the storage device 13 in association with the index specified in the step S12 so as to correspond to the timing of the change in the condition of the body of the user. That is, the electronic control unit 10 may store the index specified in the step S12 based on the change and the data related to the vehicle 1 in association with each other so that the timing of the occurrence of the change and the timing of acquiring the data related to the vehicle 1 correspond to each other when a change occurs in the condition of the body of the user. The data relating to the vehicle 1 may include, for example, data acquired by the sensor device 40. The data relating to the vehicle 1 may include data indicating at least a part of a load state of the processor 11, a usage rate of the memory 12, a communication state by the communication device 20, and a state of the control component 30.

As described above, according to the present embodiment, the electronic control unit 10 specifies the index based on the amount of change in the state of the body of the user who is the driver detected in the vehicle 1 controlled by the automatic driving function or the driving assistance function. In addition, the electronic control unit 10 stores the data related to the vehicle 1 in association with the index so as to correspond to the timing of the change in the state of the body of the user. As a result, in a case where a predetermined amount of change occurs in the state of the body of the user, it is possible to easily identify the data related to the vehicle 1 when the change occurs, out of the data stored in the storage unit 103. That is, according to the present embodiment, it is possible to record data more effectively in a vehicle controlled by an automatic driving function or a driving assistance function.

Modifications

The program for mounting the system 100 (or the vehicle 1 or the electronic control unit 10) in the present embodiment can be recorded in various recording media such as an optical disk such as a CD-ROM, a magnetic disk, and a semiconductor memory. In addition, the program can be installed or loaded on a computer by downloading the program through a recording medium or via a communication network or the like.

The present disclosure is not limited to the above-described embodiments, and can be implemented in various other forms without departing from the gist of the present disclosure. The above-described embodiments are merely illustrative in all respects, and are not to be construed as limiting.

What is claimed is:

1. An in-vehicle device comprising:
an identification unit that identifies an index based on a change amount of a state of a body of a user detected in a vehicle controlled by an automatic driving function or a driving assistance function; and
a storage unit that stores data related to the vehicle in association with the index such that a timing of acquisition of the data corresponds to a timing of a change of the state.

2. The in-vehicle device according to claim 1, wherein the identification unit identifies the index in response to an occurrence of a predetermined event related to control by the automatic driving function or the driving assistance function.

3. The in-vehicle device according to claim 1, wherein the storage unit stores the data stored in association with the index with a higher priority than other data.

4. The in-vehicle device according to claim 1, wherein the index indicates a higher priority as the change amount of the detected state increases.

5. The in-vehicle device according to claim 4, wherein the storage unit stores the data for a longer period of time as the index associated with the data indicates a higher priority.

6. The in-vehicle device according to claim 4, comprising an output unit that preferentially outputs the data as the index associated with the data indicates a higher priority.

7. The in-vehicle device according to claim 1, wherein the index is a value calculated based on a change amount of at least a part of a volume of a voice, an expression, a facial color, a pupil position, a pupil size, and a body position of the user.

8. A control method performed by a processor of an in-vehicle device, the control method comprising:
identifying an index based on a change amount of a state of a body of a user detected in a vehicle controlled by an automatic driving function or a driving assistance function; and
storing a storage unit that stores data related to the vehicle in association with the index such that a timing of acquisition of the data corresponds to a timing of a change of the state.

9. A non-transitory storage medium storing a program that causes a computer to function as an in-vehicle device, the in-vehicle device comprising:
an identification unit that identifies an index based on a change amount of a state of a body of a user detected in a vehicle controlled by an automatic driving function or a driving assistance function; and
a storage unit that stores data related to the vehicle in association with the index such that a timing of acquisition of the data corresponds to a timing of a change of the state.
